(19) United States
(12) Patent Application Publication
(10) Pub. No.: US 2021/0362543 A1
(43) Pub. Date: Nov. 25, 2021

(54) Smart Wheel Traction System (SWTS)

(71) Applicant: Reginald Bertram Howard, Worcester, MA (US)

(72) Inventor: Reginald Bertram Howard, Worcester, MA (US)

(21) Appl. No.: 16/999,063

(22) PCT Filed: Apr. 10, 2018
(86) PCT No.: PCT/US2018/020988

§ 371 Date: Aug. 21, 2020

(51) Int. Cl. B60B 15/14; B60T 8/171; B60T 8/1761

(52) U.S. Cl. CPC B60B 15/14; B60T 8/1761; B60T 8/171

(57) ABSTRACT

This invention is an improvement to the universal brake system (UBS) with adjustable wheel traction system (WTS). It adds a smart wheel that operate as a standalone adjustable wheel traction system with no connections to a vehicle's ABS brake system. The smartphone integrate with the wheel traction system to provide the following features: 360-degree collision avoidance, 360-degree parking guidance, 360-degree vehicle security and emergency calling. The smart wheel can also integrate with the UBS to obtain wheel lock features. The smart wheel utilizes four radially spaced spikes separated by 90 degrees that operate individually via linear actuators. Each smart wheel has a wireless remote terminal unit embedded in each wheel that measures the angular velocity of each wheel with one wheel serving as a master remote terminal unit that monitors the speed of each wheel to determine when slip or skidding occurs and when to extends wheel spikes.

### CROSS-REFERENCE TO RELATED APPLICATIONS (MPEP 201.11)

None

### STATEMENT REGARDING FEDERALLY SPONSORED RESEARCH OR DEVELOPMENT: (MPEP 310)

N/A

### THE NAMES OF THE PARTIES TO A JOINT RESEARCH AGREEMENT (37 CFR 1.71 (G)

N/A

### REFERENCE TO A “SEQUENCE LISTING,” A TABLE, OR A COMPUTER PROGRAM LISTING APPENDIX SUBMITTED ON COMPACT DISC AND AN INCORPORATION-BY-REFERENCE OF THE MATERIAL ON THE COMPACT DISC

N/A

### BACKGROUND OF THE INVENTION ((MPEP 608.01(C))

U.S. Pat. No. 9,815,325-B2 discloses a universal braking system with adjustable wheel traction that utilizes a plurality of spikes embedded in a vehicle's wheel rim. The spikes are extended and retracted using a motor/linear actuator motors that is concentric located on a disc with a disc gear mounted on the other edge of the disc for each spike. The rotation of the disc by the motor/linear actuator motors causes each disc gear to mesh with each spike gear to cause each spike to move outward and proportionally to the turn of the disc. The extension of each spike causes it to penetrate through a hole in a tire and meet a road surface or support surface. This configuration also requires an inner tube to be inserted in a tire since the design has not defined a way to make the hole in the tire airtight. Each spike is heated using an electric heating element with a nonfreezing fluid which circulates in a channel that house each spike. The nonfreezing fluid is heated via an electric heating element. The entire system is controlled and monitored by a UBS computer control system.

### BRIEF SUMMARY OF INVENTION

This invention relates to a universal brake system (UBS) that combines features from a prior art anti-lock brake system (ABS) with adjustable wheel traction system (AWT) and with improved technology called smart wheel. This UBS features provides a vehicle operator with the ability to control skidding and reduce a vehicle stopping distance on dry road surfaces and particularly on slippery rigid road surfaces e.g. wet roads, ice covered roads, or snow-covered roads and non-rigid surfaces such as sand and loose gravel. It is important to note that today's conventional ABS's are most effective on dry rigid road surfaces e.g. concrete or asphalt and less effective on slippery wet, icy or snow covered rigid road surfaces and non-rigid surfaces such as sand and loose gravel. This is due to the obvious lack of tire traction on these types of surfaces which can make controlling a vehicle's skidding almost impossible with just an ABS. Hence, the invention of the UBS solves the problem with the lack of wheel traction (friction) and skid control on dry, wet, frozen and slippery roads consisting of rigid surfaces and non-rigid surfaces by utilizing an adjustable wheel traction system that can extend and retract wheel spikes on demand as a result of a vehicle operator pressing a vehicle's brake pedal, and using the brake system controller to alternate between locking a wheel on a spike long enough time for it to penetrate one of said mentioned types of road surfaces and then measuring the wheel slip of the rear wheel and switching back to anti-lock and anti-skid mode momentarily. This cycle is repeated until the slip that cause the wheel to lockup goes away.

The wheel traction system consists of a plurality of spikes embedded in a wheel's housing and controlled by a brake system microprocessor controller which can automatically upon pressing a vehicle's brake pedal extend spikes 14 outward beyond a wheel's supporting surface to create friction (traction) with a wheel's supporting surface. The spikes are automatically retracted when a vehicle's operator release the brake pedal if the unit is operating in the automatic mode.

The wheel traction system has several modes of operation that determines how much the plurality of spikes extends outward beyond a wheel surface. The modes of operation are based on the types of road surfaces and road conditions a vehicle will be driven on. A summary of the different modes of operation: A) Dry mode—no spikes are extended, and the braking system works as an anti-locking braking system with continuous wheel slip control. B) Wet Mode—A plurality of spikes are extended a predetermined distance upon a vehicle operator pressing a vehicle brake pedal. In this mode, the braking system microprocessor controller allows a wheel to momentary lockup on a spike long enough time for it to dig-into a supporting surface to create traction (friction) between a wheel and its supporting surface. C) Ice Mode—works the same as wet mode except the predetermined distance that spikes are extended is a little more than in the wet mode. D) Snow Mode—works the same as the ice mode except the predetermined distance spikes are extended is a little more than the ice mode.

The wheel traction system has two configurations: a) The wheel traction system is integrated into a vehicle's wheel assembly. This configuration is best suited for new vehicles or vehicles that are having their wheels replaced to take advantage of the safety features of the wheel traction system. b) The second configuration is an independent adapter to be mounted outside of an existing vehicle's wheel. This configuration is designed mainly to adapt to an existing vehicle wheel. Power for the wheel traction system is via a fly wheel generator mounted inside a wheel assembly or adapter assembly, a battery pack and solar panel with charge controller. Communication to the wheel retraction system is via a wireless remote terminal unit (RTU) 33 microprocessor controller mounted internally to the wheel assembly or adapter assembly and communicates wirelessly with a vehicle's wireless brake RTU 50 controller and/or engine control unit (ECU). An alternate method of communication is via hardwired connections between RTU's and ECU.

Traction is obtained from a plurality of spikes configured on a circle disc with each spike having its own gear 16 that mesh with a gear on the gear disc 23. Each spike has a solenoid 25 control latch 26 that allows the spike to be release and extend under the power of a stepper motor 21 and latch in place when extended. Each spike has means to absorb shock via spring 14A. Solenoid 25 pulls the latch 26 away to allow the spike to retract under the power of spring 17 when a brake pedal is released. Individual wheel rotational velocities are controlled by selective operation of dump and apply valves that control the wheel brake pressure applied at each of the wheels. The operation of the valves provides three modes of operation, namely, dump to reduce the applied pressure, apply to increase the applied pressure, and hold to maintain the applied pressure at the current level.

### BRIEF DESCRIPTION OF UBS DRAWINGS

FIG. 1. Wheel Traction System Adapter Assembly—Shows the components and assembly of a wheel traction system adapter attached to a vehicle's wheel.

FIG. 2. Wheel Traction Adapter Assembly Left Side view—A side view of the assembly of a wheel traction system attached to a vehicle's wheel.

FIG. 3. Wheel Traction Assembly with Spikes Retracted Front View—A front view of the wheel traction system with the spikes retracted.

FIG. 4. Wheel Traction Assembly with Spikes Extended Front view—A front view of the wheel traction system with the spikes extended.

FIG. 5 Wheel Traction System Installed Inside Wheel Assembly—illustrates how the wheel traction system is installed inside a vehicle's wheel.

FIG. 6. Wheel Traction System Major Component Wiring Diagram—Illustrates the wiring of major components of the wheel traction system.

FIG. 7. Universal Braking System Schematic—Shows how electrical components of the UBS are wired and their location in a vehicle.

FIG. 8. Wheel Traction System Adapter Schematic block diagram—Illustrates the wiring of major computer components of the wheel traction system.

FIG. 9. Wheel Position Sensor Assembly—illustrates how start and stop detectors and magnetic sensors are installed on a vehicle's wheel.

FIG. 10. Universal Braking System overall system components—A schematic diagram showing major components of the UBS installed in a rear wheel vehicle.

FIG. 11. Universal Braking System Computer Algorithm—A flow chart of the braking system computer algorithm that is in accordance with the invention.

FIG. 12 ABS Prior Art References—Vehicle speed sensor signal circuit combination and a typical vehicle brake and wheel assembly with ABS components installed.

FIG. 13. Magnetic Position Detector—Assembly drawing of the wheel position sensors and detectors.

FIG. 14 illustrates the pressure being applied in the dry mode to one of the wheel brake cylinders as a function of time. At t₁ the brake pedal 12 is depressed to begin applying pressure to the brake cylinders.

FIG. 15 Demonstrate slippery mode operation and by showing actual vehicle speed during heavy braking application on a slippery road with wheel traction system active. The actual wheel speed begins to decrease relative to the actual vehicle speed as heavy braking begins. Meanwhile, the microprocessor in the ECU 54 has calculated a theoretical speed ramp based on the selected slippery road surface that represents the speed the vehicle would travel when decelerated at a predetermined maximum rate, such as 1.0 g. When the difference between the actual wheel speed and the calculated speed ramp exceeds a predetermined slip threshold Sₜ, it is an indication that the wheel has potential to lock-up at t₁. The ECU then reads the spike start detector 44 on the slipping wheel for the next available spike, reads the spike status switch 42 for an open status, then the microprocessor causes the apply valve associated with the wheel brake to close, as illustrated in FIG. 19, causing the wheel to lockup for a predetermined amount of time up to t₂.

FIG. 16 shows the actual vehicle speed during brake application in the dry road mode (wheel traction system in active) as a function of time as illustrated by the line labeled 92. After t₁, the actual wheel speed 93 begins to decrease relative to the actual vehicle speed 92. Meanwhile the microprocessor detects that the wheel deceleration has reached a predetermined threshold value, such as 1.3 g, at t₂. The microprocessor continues to monitor the speed of the wheel relative to both the actual wheel speed and theoretical speed ramp. When the microprocessor detects that the wheel deceleration has reached a predetermined threshold value, such as 1.3 g, at t₂, the microprocessor causes the isolation valve associated with the wheel brake to close, as illustrated in FIG. 17, limiting the pressure applied to the wheel cylinder of a constant level P_{A} in FIG. 14.

FIG. 17 shows at t₂ the microprocessor in dry road mode causes the isolation valve associated with the wheel brake to close, and limiting the pressure applied to the wheel cylinder of a constant level P_{A}. The uncontrolled wheel brake pressure would continue to follow the dashed curve labeled 45 in FIG. 1.

FIG. 18 illustrate the operation of the dump valve in the dry road mode. Upon correction of the second wheel speed departure with a second series of dump pulses, it is seen that the applied pressure P_{C} while lower that the initial pressure P_{A}, as shown in FIG. 14 is greater than the pressure P_{B} present after correction of the first wheel speed departure. Thus, it is seen that the UBS provides control over the individual wheel speeds by switching between hold, dump and apply modes of operation of the solenoid valves included in the control valve 16.

FIG. 19 Illustrates the operation of the apply valve for dry road mode. It is desirable for the ECU microprocessor to apply a series of pulses at t₅ to the apply valve associated with the wheel cylinder to raise the pressure. These pulsed precipitate a second wheel speed departure at t₆.

Brief Description of Improvements consisting of adding Smart Wheel Features in FIG. 20 thru FIG. 29:

FIG. 20 Single Spike System Assembly—Illustrates a single spike system assembly.

FIG. 21 Dual Spike System Assembly—Illustrates dual spike system assembly FIG. 22 Spike Layout—Sideview of wheel showing spike positions FIG. 23 Smart Wheel with Single Spike Row—Illustrate wheel with single row of spikes

FIG. 24 Smart Wheel with Multiple Spike Rows—Illustrates wheel with multiple rows of spikes

FIG. 25. Smart Wheel Overall Schematic—Illustrates overall schematic of smart wheel

FIG. 26. Smart Phone Controller—Illustrates basic smartphone layout

FIG. 27 Security & Radar Coverage—Illustrates security and radar 360-degree coverage

FIG. 28 Spike Position—Vehicle Level—Illustrates position of spikes and magnetic detectors when vehicle body is level

FIG. 29 Spike Position—Vehicle not Level—Illustrates position of spikes and magnetic detectors when vehicle body is not level

### DETAILED DESCRIPTION OF UBS

The universal braking system comprises: An adjustable wheel traction system configured as either a standalone wheel adapter or integrated into a vehicle's wheel assembly comprising:

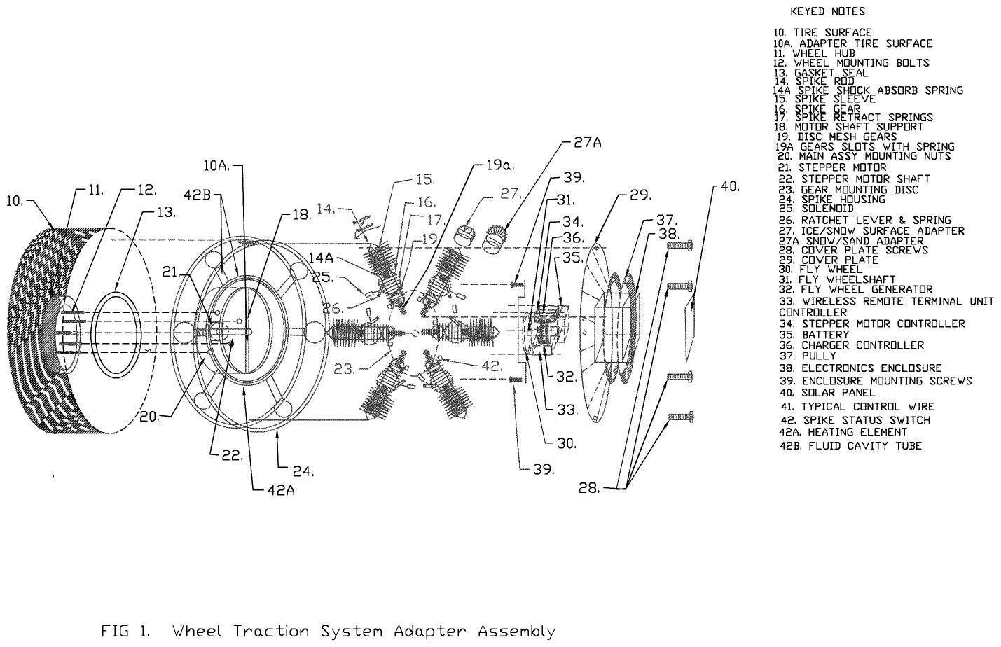

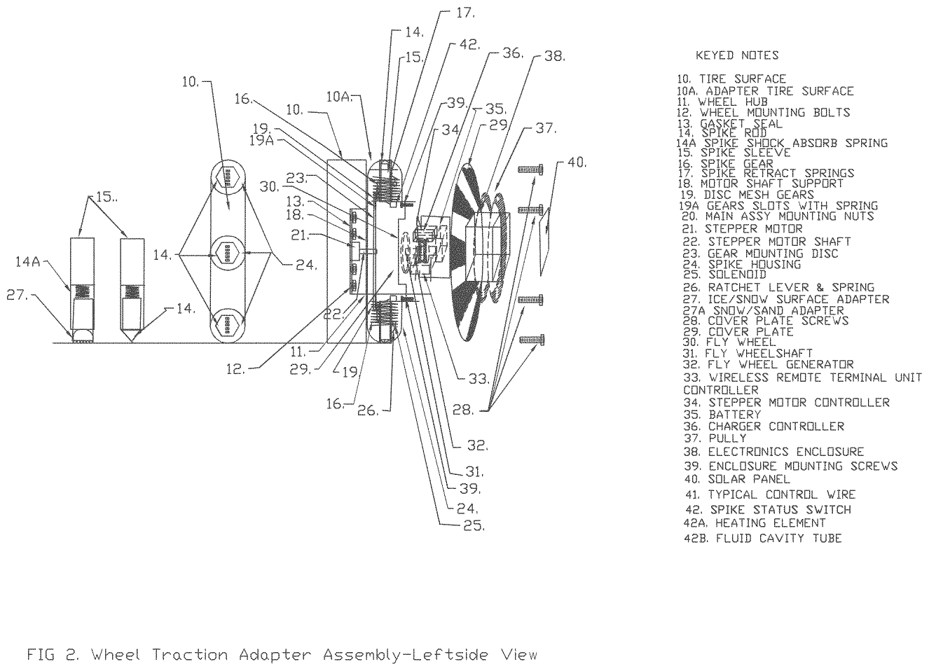

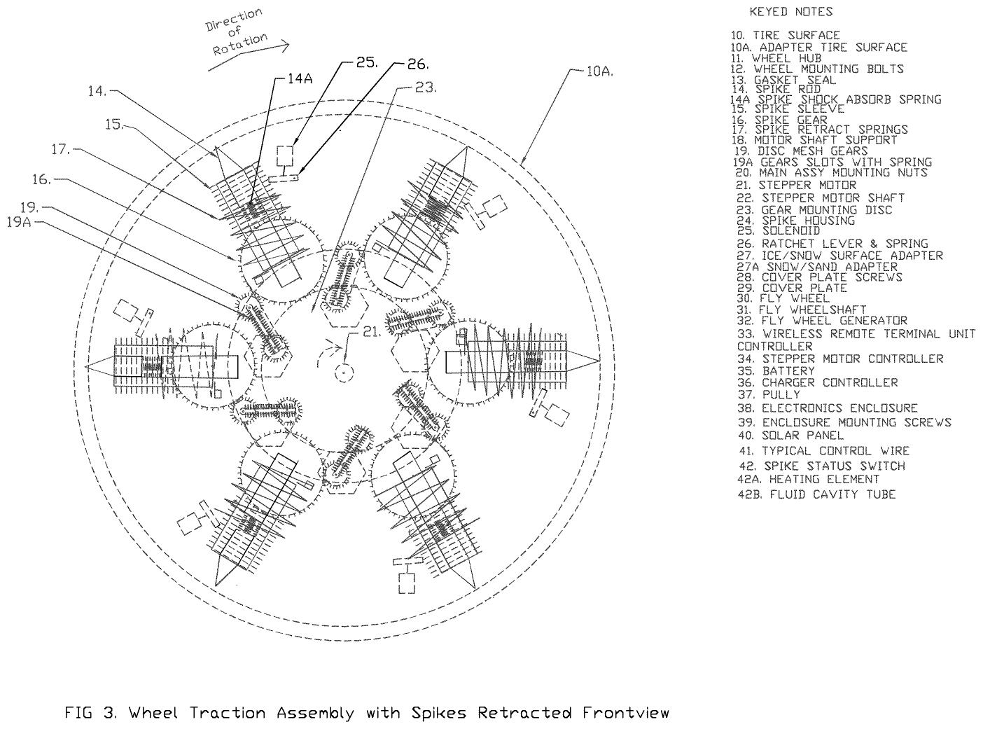

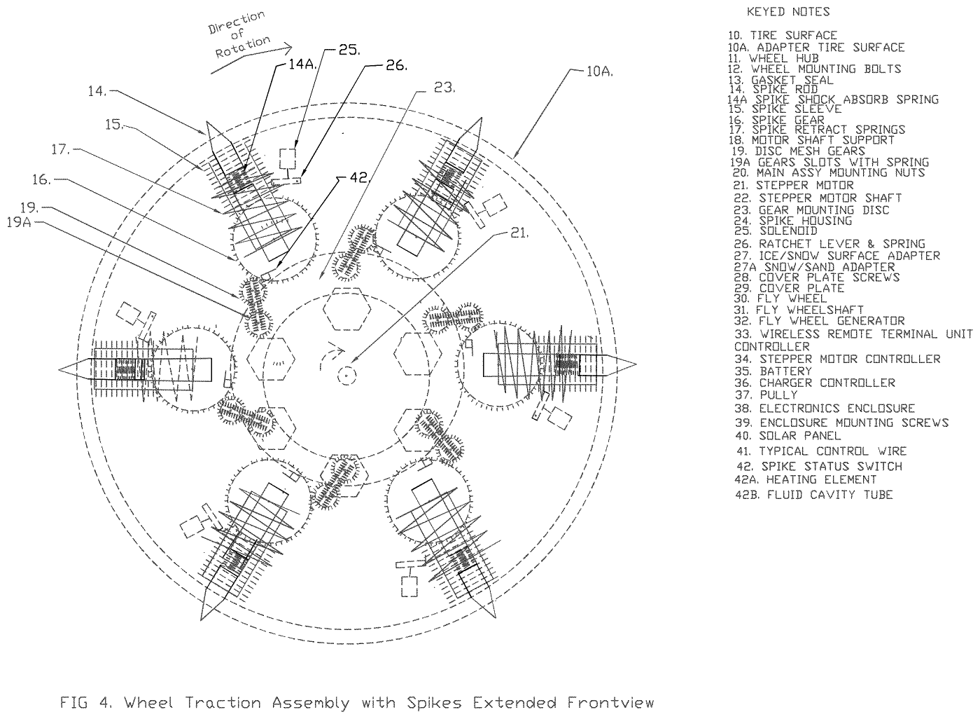

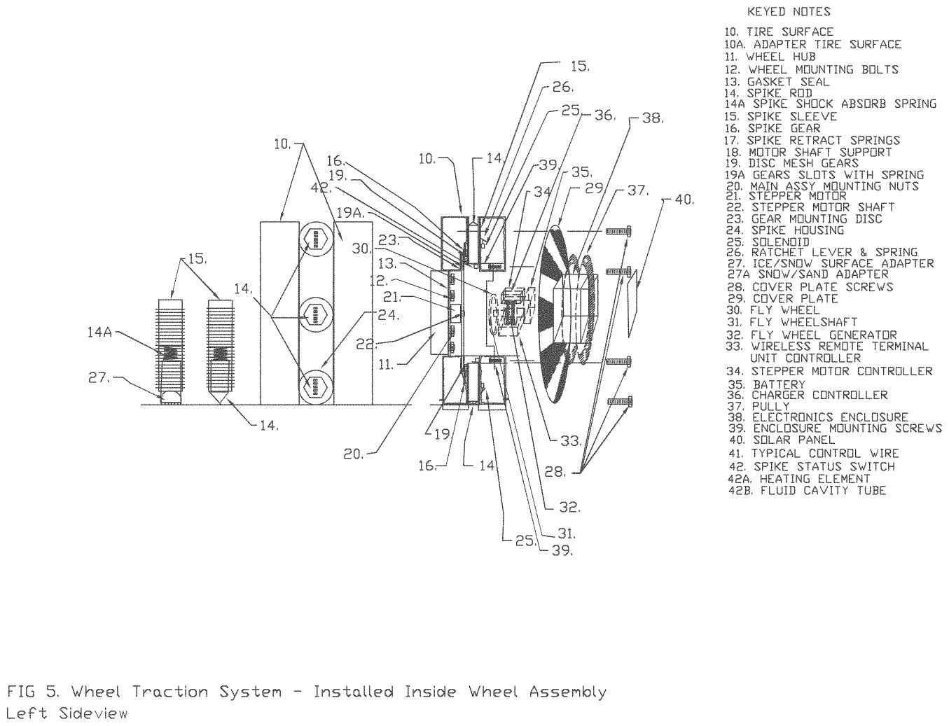

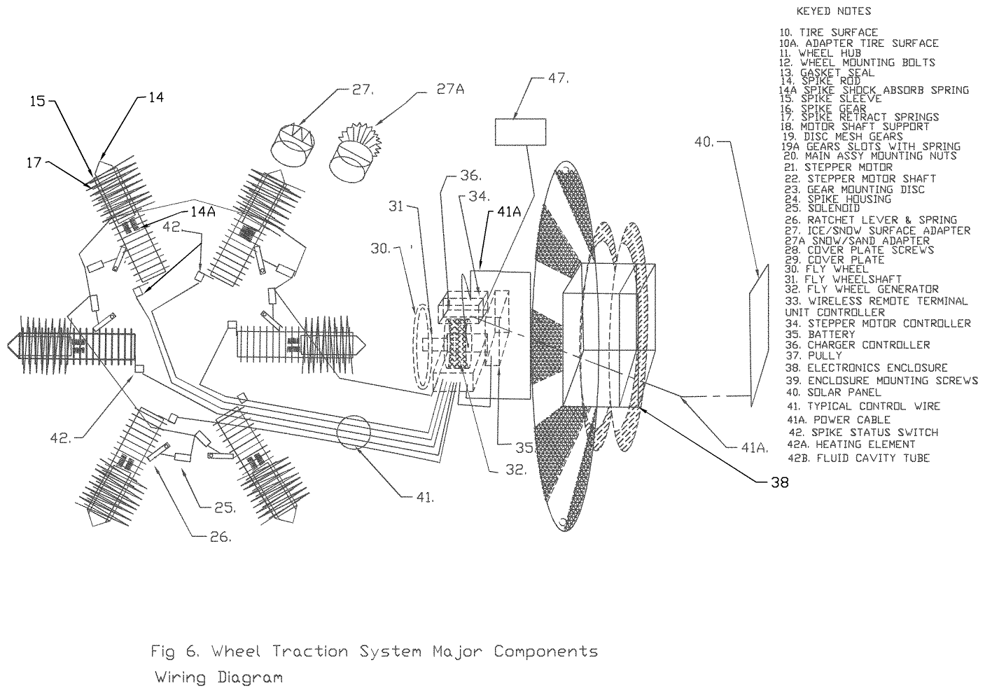

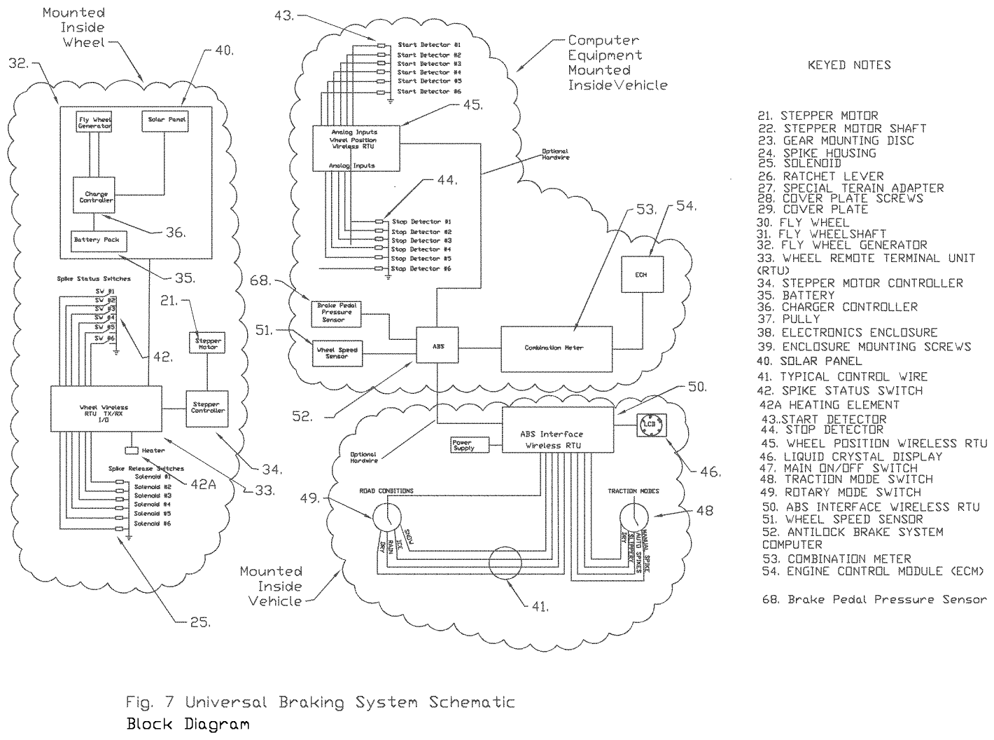

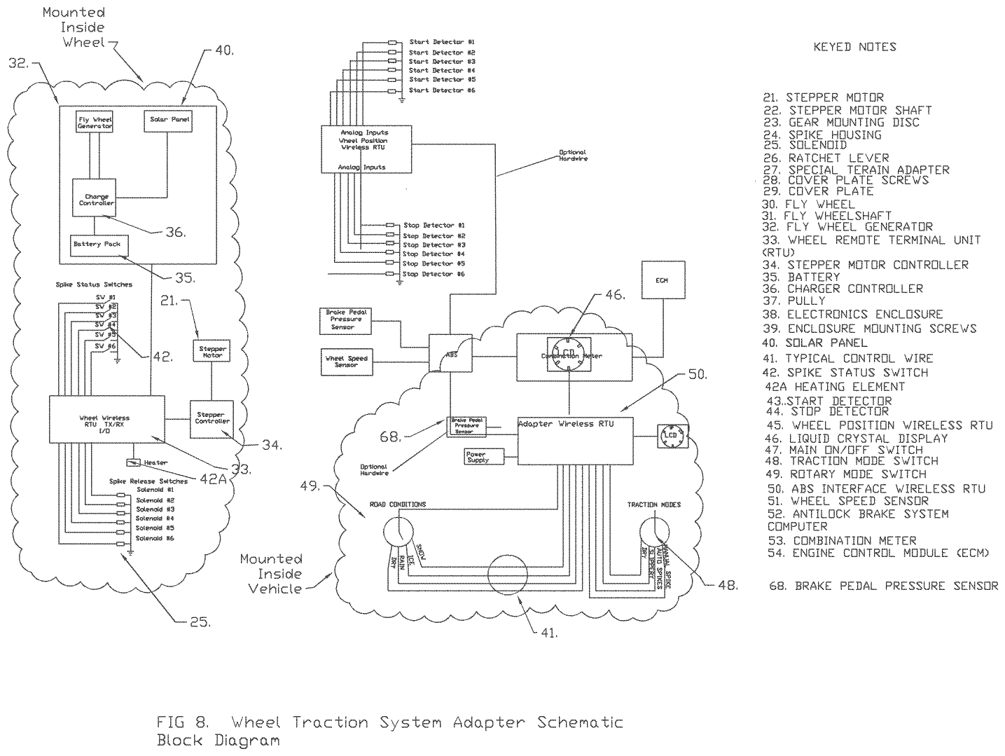

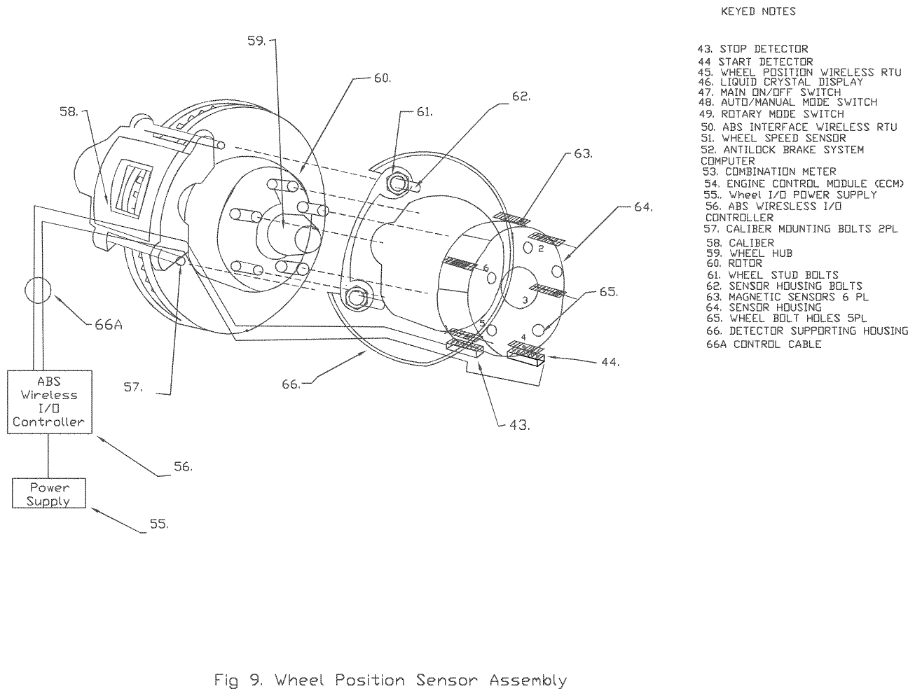

An adapter housing 24 FIG. 1 containing a plurality of spikes 14 with teeth for latching to solenoid 25 and mounted internally to housing 24 in a circular pattern and capable of automatically extending under the power of a stepper motor 21 and retracting under the power of spring 17, means for spike to absorb shock via spring 14A, said spike has interchangeable terrain adapters 27 and 27A used to improve friction with a wheel's supporting surface, said spike has sleeves 15 to protect spike from debris and other foreign matter, outer rim of adapter housing 24 is a flexible surface 10 capable of supporting a vehicle if the main tire becomes flat, said housing contain plurality of elongated water tight cavities 42B running parallel to each spike and combining in a circular ring and containing an antifreeze coolant with an electric heating element 42A for heating said fluid, each said spike 14 contains a gear 16 that mesh with a mating gear 19 mounted near outer edge of main gear disc 23, said mating gears 19 are mounted in a slot 19A and under spring tension to allow said gear to move under spike gear 16 if a spike becomes stuck, said gears diameter is set to determine the maximum distance each spike can extend, said spikes extend outward pass a wheel's supporting surface a predetermined distance in order to cause friction (traction) with a wheel's supporting surface, said spike is extended a predetermined distance selected based on the friction coefficient of a supporting rigid or non-rigid surface such as that of slippery surfaces of a wet roads, ice covered roads, snow covered roads, sand covered roads or loose gravel roads, said spike extend and retract proportionate to the amount of brake pedal 67 pressure being measure by brake pedal pressure sensor 68, said spikes contain means for locking extended spikes with latching solenoid 25 and ratchet lever 26, said spike is mechanically in contact with normally closed micro switch 42 that opens when a spike has extended outward from its housing, a means for self-powering unit via a fly wheel generator 32 centrally mounted, said fly wheel 30 of generator builds up angular momentum as a vehicle's wheel rotates, said fly wheel rotates during braking to cause generator shaft to turn generator and produce electricity to power unit, said fly wheel generator 32 also provides power to charge a battery 35 via a charge controller 36 that is centrally mounted, a solar panel 40 is mounted on the outside wall of adapter cover housing 29 and provides electricity when there is sun light to charge battery 35 via a charge controller 36, all electrical component are controlled by a centrally mounted wireless remote terminal unit RTU controller 33 mounted inside adapter housing or inside wheel assembly and is capable of wireless or wired communication with the brake system wireless RTU controller 52 and engine control unit (ECU) 54 per computer algorithm in FIG. 11, said RTU 50 has a display 46 to display the status of system components, as an alternate configuration, wheel traction system can be part of a vehicle's wheel assembly FIG. 5 with all the same features mentioned above for the adapter unit, in addition both configurations can be configured for wireless communication with the braking system computer FIG. 7 and operated per computer algorithm FIG. 11. To provide complete wheel traction and skid control on dry, wet, frozen, slippery, rigid, and non-rigid road surfaces, the UBS integrates the above mention wheel traction system with features from prior art European Patent 1 603 781 B1 Anti-Lock Braking System. This combination makes the UBS a multifunctional system that is capable providing a vehicle with additional wheel traction and skid control on dry, wet, frozen, slippery, rigid and non-rigid road surfaces depending on the terrain adapter selected and the depth of penetration of the wheel spikes.

Configured as a standalone wheel adapter FIG. 1 the wheel traction system per computer schematic FIG. 8 can be controlled by a vehicle operator with wireless communications from its main remote terminal controller (RTU) 33 to a second wireless RTU 50 mounted inside of a vehicle with operator inputs from a rotary switch 49 for operator to select a predetermined amount of spike penetration distance based on a wheel's supporting surfaces e.g. wet road, ice covered road or snow covered roads and inputs from rotary switch 48 that selects manual traction or automatic traction. A fully configured UBS has the following modes of operation:

Traction Modes
Manual Traction—Function as an adjustable wheel traction system with spikes locked in a fully extended position. Spikes extended length is selectable based on road conditions e.g. wet conditions, Icy conditions, snowy conditions.
Auto Traction—Function as an adjustable wheel traction system with spikes extending automatically and proportionate to the amount of brake pedal pressure. Spikes extension length is selectable based on road conditions e.g. wet conditions, icy conditions, or snowy conditions.
Slippery Roads—Functions as a complete universal brake system that alternate between lock brakes and anti-lock brakes controls while using an adjustable wheel traction system to gain traction on slippery rigid or non-rigid road surfaces such as wet roads, ice or snow-covered roads or non-rigid surfaces such as sand or loose gravel covered road surfaces. Spikes extended length is selectable based on road conditions e.g. wet conditions, icy conditions, and snowy conditions.
Dry Road—Function as an anti-lock brake system with continuous slip control. Wheel traction system is inactive in this mode.

* For all slippery modes, the terrain adapter 27 and 27A are selected to match road conditions to create the maximum amount of friction between a wheel and its supporting surface.

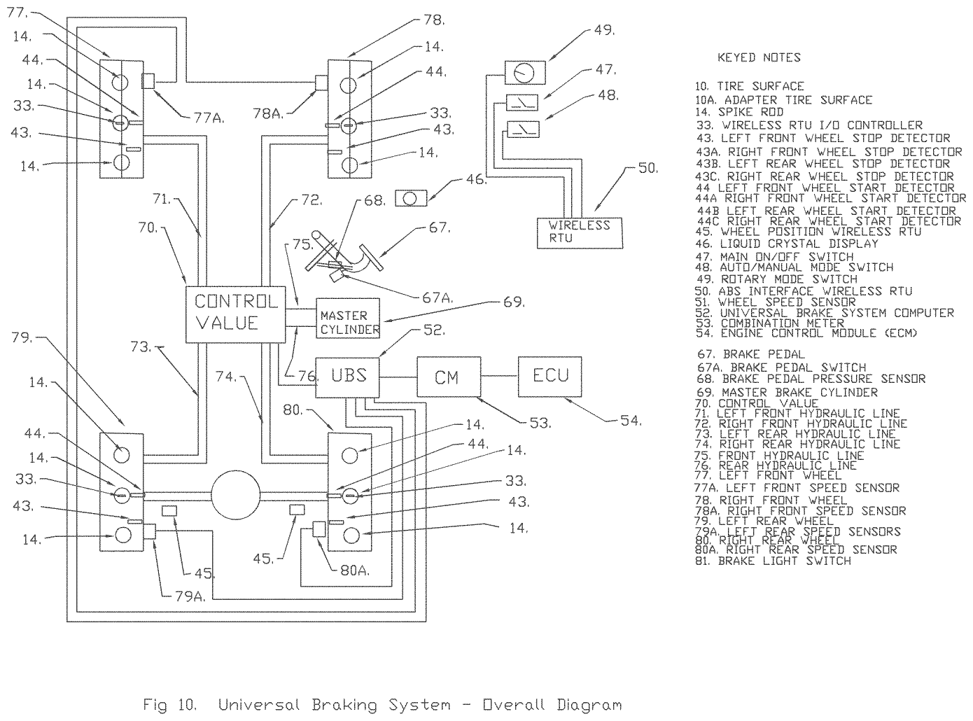

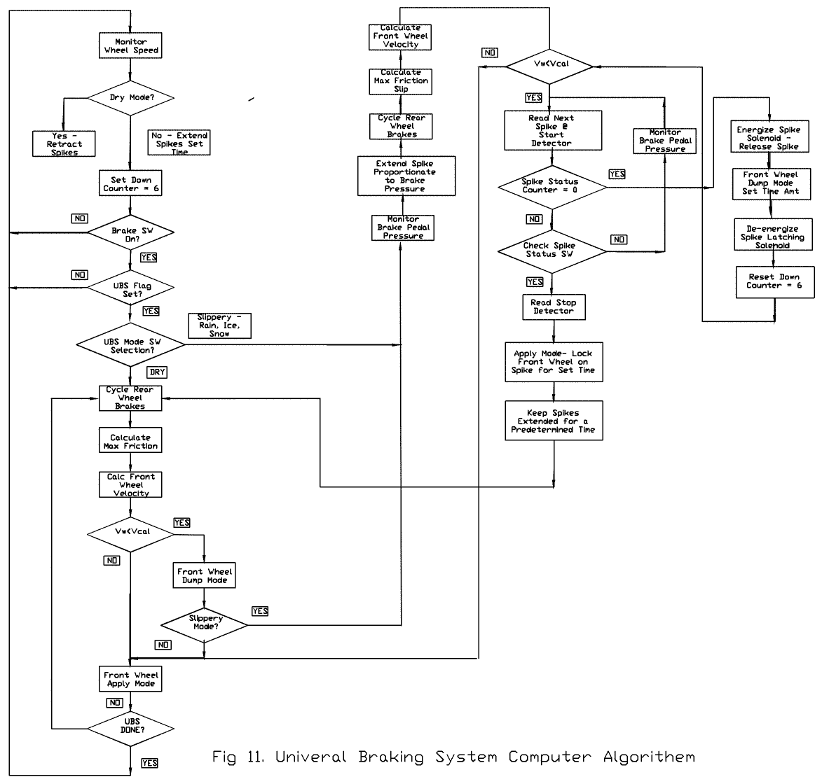

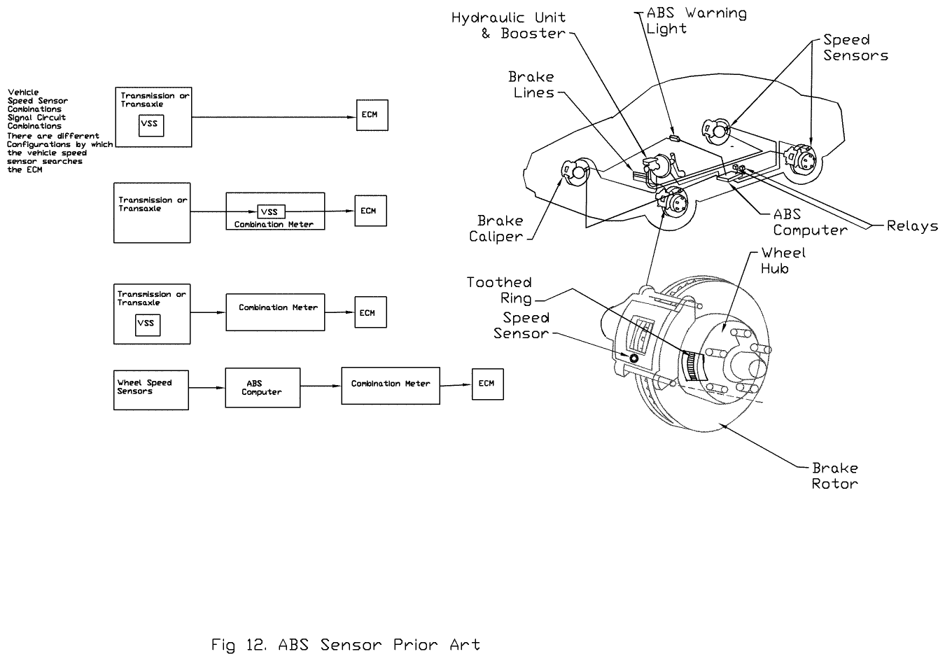

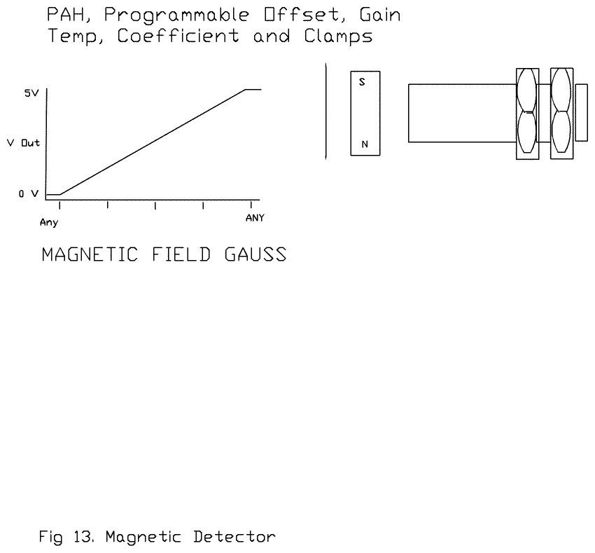

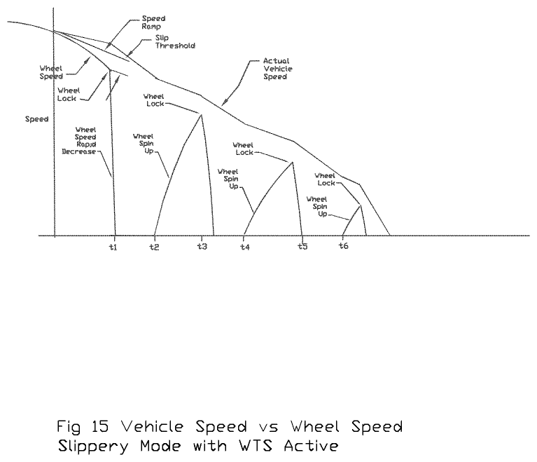

In manual spike mode said spikes stay extended a fix predetermined distance based on road conditions. In this mode said spikes 14 will stay extended until the unit is switch to automated mode or any other position, in automatic spike mode spikes will extend and retract proportionate to the brake pedal 67 FIG. 10 with pressure measured by sensor 68. Spikes extension length is selectable based on road conditions e.g. wet condition, icy conditions, and snowy conditions. In slippery mode the system is characterized as having all the features of a universal brake system. The wheel traction system described above is active upon an operator pressing said brake pedal 67 along with brake switch 67A closing will cause a brake pressure to be measured at sensor 68, said spikes will extend proportionately to the amount of brake pedal pressure based on road conditions, e.g. wet conditions, icy conditions, or snowy conditions, a means for measuring wheel speeds (77,78,79,80) FIG. 10, a means to detect the start position 44 and stop position 43 of each spike, a means for sensing 42 when a spike has extended from its housing, a mechanical means for extending spikes from their housing via stepper motor 21 and gear disc 23 and retracting said spikes via power from spring 17, a wireless communication means for interfacing with brake system computer 52 and ECU 54, a road condition switch 49 to select a predetermined depth of penetration of spikes 14 based on the friction coefficient of different type of road surfaces and other road conditions previously mentioned above, a fly wheel generator 32 centrally mounted in a wheel assembly FIG. 5 or in adapter assembly FIG. 1 for supplying power to all system components, a solar panel 40 and charge controller 36 and a battery pack 35 with entire unit constructed in a matter that keeps a wheel balanced; there is an adjustable modulator (not shown), for increasing a hydraulic pressure to oil cylinders of the left and right, and front and rear wheels of the vehicle in a hydraulic pressure increase mode, holding as is the current value of the hydraulic brake pressure in a hydraulic pressure holding mode, and for reducing the hydraulic brake pressure to the oil cylinder of said left and right, and said front and rear wheels of said vehicle in a hydraulic pressure reduction mode; a detection means for detecting the speed (77A, &78A) of said left and right, and said front and rear wheels (70A, 80A) of said vehicle; a slip detection means for judging by evaluating signal outputs from said detection means whether or not a slip of the extent to which momentary wheel-lock control is necessary to allow spikes time to penetrate slippery surface in order to generate traction (friction) between the wheel and supporting surface in any of the front, rear, left and right wheels of said vehicle and a controller 52 which controls the modulator based on the judged result of said slip detection means, and which selects and sets one of said hydraulic pressure increase mode, said hydraulic pressure holding mode and said hydraulic pressure reduction mode for each wheel. The braking controller provides the ability to read the spike start detector 44 to detect the next available spike, read the spike status switch 42, and then lock-wheel for a predetermined time on next available spike once it passes under the stop detector 43, each momentary wheel-lock to be followed by a return to the anti-lock mode with anti-skid control FIG. 15, after each initial wheel-lock condition spikes will remain extended for a predetermined time to insure vehicle does not immediately return into a skid; when in slippery mode the slip detection means judged that the locked brake control is necessary based on a predetermined slip threshold setting; a hydraulic pressure control means for setting said adjustable modulator at either the pressure maintaining mode or the pressure reduction mode with regard to the wheel for which the momentary locked brake control has been set by said brake lock control setting and then alternating back and forth between locked brake on next available spike and anti-lock brake mode with wheel traction active until the slipping which triggered the lock brake control disappears FIG. 15, when the slipping disappears, set the adjustable modulator at the pressure increase mode in condition that the wheel speed of the wheel is increasing; and a pressure increase restriction means for determining whether slip is increasing at the pair of front or rear wheels to which the wheel the pressure increase mode is set does not belong, and converting the pressure increase mode to either the pressure maintaining mode or the pressure decrease mode if the slip at the pair of front or rear wheels is increasing. In the event the spikes fail to extend as measured by reading a closed switch for all spikes status switches 42 after UBS controller command to extend spikes, next UBS controller will energize latching solenoids to unrestricted wheel spikes and then momentarily enters dump mode to relieve brake pressure and allow wheel to spin up such that the spikes can be released by centrifugal force then controller release solenoid to latch spikes in places. UBS brake controller to operate per computer algorithm in FIG. 11.

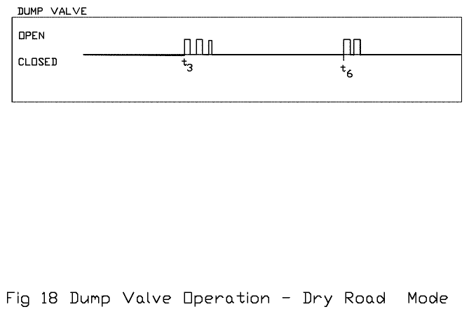

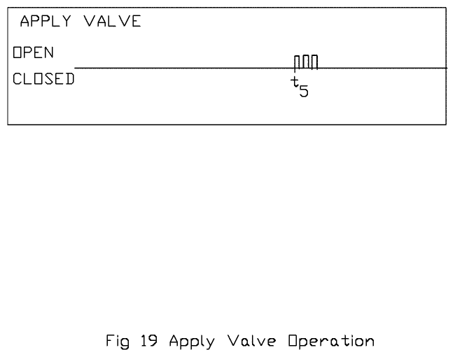

The operation of the UBS in slippery mode is demonstrated in FIG. 15 which illustrates actual vehicle speed during heavy braking application on a slippery road with wheel traction system active. The actual wheel speed begins to decrease relative to the actual vehicle speed as heavy braking begins. Meanwhile, the microprocessor in the ECU 54 has calculated a theoretical speed ramp based on the selected slippery road surface that represents the speed the vehicle would travel when decelerated at a predetermined maximum rate, such as 1.0 g. When the difference between the actual wheel speed and the calculated speed ramp exceeds a predetermined slip threshold Sₜ, it is an indication that the wheel has potential to lock-up at t₁. The ECU then reads the spike start detector 44 on the slipping wheel for the next available spike, reads the spike status switch 42 for an open status, then the microprocessor causes the apply valve associated with the wheel brake to close, as illustrated in FIG. 19, causing the wheel to lockup for a predetermined amount of time up to t₂. The wheel speed remains at zero until t₂ at which time the ECU selectively reduce the pressure of the hydraulic fluid being applied to the wheel cylinder. Accordingly, the ECU microprocessor applies a series of pulses labeled shown in FIG. 18 to the dump valve associated with the wheel cylinder to lower pressure sufficiently to cause the wheel to spin back up until the slip threshold is reached again then repeat the lock wheel cycle over per computer algorithm FIG. 11 until slippage goes away or the vehicle operator has reduced brake pedal pressure below a set pressure threshold. Once a wheel has locked, the wheel spikes will have remained extended for a predetermined time to prevent the vehicle from immediately re-entering a skid on a slippery surface.

Dry Surface Mode—which includes an adjustable modulator (not shown), for increasing a hydraulic pressure to oil cylinders of the left and right, and front and rear wheels of the vehicle in a hydraulic pressure increase mode, holding as is the current value of the hydraulic brake pressure in a hydraulic pressure holding mode, and for reducing the hydraulic brake pressure to the oil cylinder of said left and right, and said front and rear wheels of said vehicle in a hydraulic pressure reduction mode; a detection means for detecting the speed of said left and right, and said front and rear wheels of said vehicle; a slip detection means for judging by evaluating signal outputs from said detection means whether or not a slip of the extent to which anti-skid control is necessary has been generated in any of the front, rear, left and right wheels of said vehicle and a controller which controls the modulator based on the judged result of said slip detection means, and which selects and sets one of said hydraulic pressure increase mode, said hydraulic pressure holding mode and said hydraulic pressure reduction mode for each wheel. The controller provides an anti-skid control setting means for setting an anti-skid control for the wheel; the slip detection means judged that the anti-skid control is necessary; a hydraulic pressure control means for setting said adjustable modulator at either the pressure maintaining mode or the pressure reduction mode with regard to the wheel for which the anti-skid control has been set by said anti-skid control setting means until the slipping which triggered the anti-skid control disappears, and, when the slipping disappears, for setting the adjustable modulator at the pressure increase mode in condition that the wheel speed of the wheel is increasing; and a pressure increase restriction means for determining whether slip is increasing at the pair of front or rear wheels to which the wheel the pressure increase mode is set does not belong, and converting the pressure increase mode to either the pressure maintaining mode or the pressure decrease mode if the slip at the pair of front or rear wheels is increasing.

Referring to the drawings, illustrated in FIG. 10 is a typical hydraulic brake system which includes prior art anti-lock brake system (U.S. Pat. No. 5,479,567A) integrated with invention Wheel Traction System. The brake system in FIG. 10 shown is for a rear wheel drive vehicle. The universal braking system includes a brake pedal 67 that is mechanically connected to a brake light switch 67A and a dual reservoir master cylinder 69. A first reservoir of the master brake cylinder 69 provides hydraulic brake fluid to a front wheel brake circuit, while a second reservoir supplies hydraulic fluid to rear wheel brake circuit.

The master cylinder first reservoir is connected to an UBS control valve 70 by a first hydraulic line 75 the second reservoir is connected to the control valve 70 by a second hydraulic line 76. The UBS control valve 70 includes a plurality of normally open and normally closed solenoid valves (not shown) and a separate source of pressurized hydraulic fluid, such as a motor driven pump (not shown). The pump is typically included in the body of the control valve 70 while the pump is mounted upon the exterior thereof. The control valve 70 is connected by first pair lines 72 and 71 to right and left front wheels 78 and 77, respectively. For the vehicle in FIG. 10, the front wheels 78 and 77 are non-driven also having front wheel and/or all-wheel drive. Similarly, second pair of hydraulic brake lines 74 and 73 connects 70 to right and left rear vehicle wheels, respectively.

Typically, the control valve 70 includes a normally open solenoid valve (not shown) between each of the brake circuits and the corresponding master cylinder reservoir. Upon actuation, the valve closes are to isolate the brake circuit from the master cylinder 69. Accordingly, the valve is typically referred to as an isolation valve. For optimal control of the speed of each of the vehicle wheels, each of the wheel brakes can be provided an associated isolation valve. The control valve also typically includes a first normally closed valve (not shown) for each wheel brake that connects the wheel brake cylinder with a brake fluid reservoir (not shown). Upon actuation, the first normally closed valve is opened to bleed hydraulic fluid from the wheel brake cylinder and thereby reduce the pressure applied to the wheel brake. Accordingly, the first normally closed valve is usually referred to as a dump valve. The control valve also usually includes a second normally closed valve (not shown) for each wheel brake that connects the wheel brake cylinder with an outlet of the pump. Upon actuation, the first normally closed valve is opened to supply pressurized hydraulic fluid from the pump to the wheel brake cylinder and thereby raise the pressure applied to the wheel brake. Accordingly, the second normally closed valve is usually referred to as an apply valve. The reservoir connected to the dump valves is connect to the pump inlet and thereby supplies hydraulic brake fluid to the motor driven pump.

The speed of the front wheels 78 and 77 are monitored by a first pair of wheel associated wheel speed sensors 78a and 77a, respectively. Similarly, the speed of wheels 80 and 79 of associated wheel speed sensors 80a and 79a, respectively. The wheel speed sensors 77a, 78a, 79a and 80a are electrically connected to an UBS electronic control unit (54). Closing the brake switch 67a provides a signal to the ECU 54 that the vehicle brakes have activated. The ECU 54 also is electrically connected to the pump motor and the actuation coils of the solenoid valves included with the control valve 70. The ECU 54 includes a microprocessor with a memory that stores an UBS control algorithm FIG. 11.

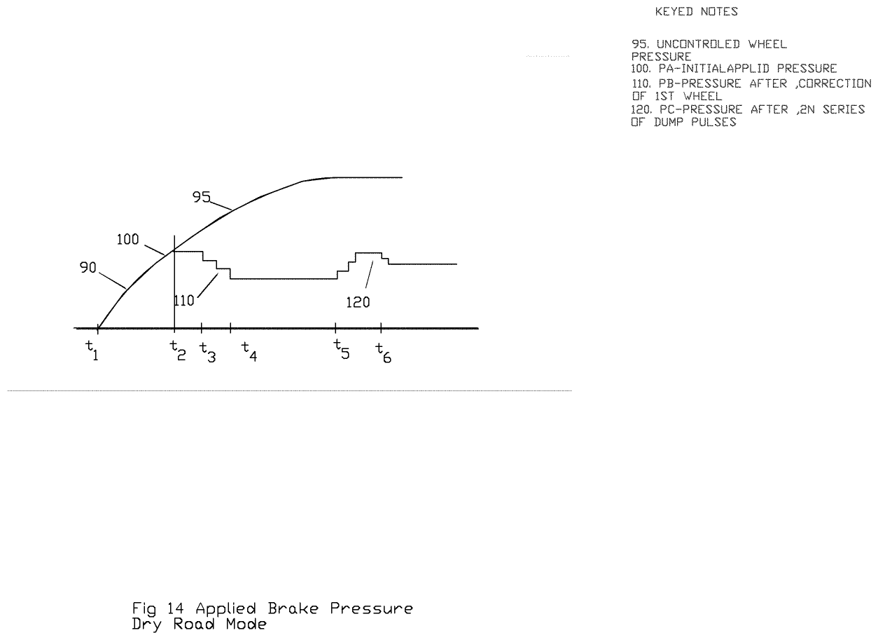

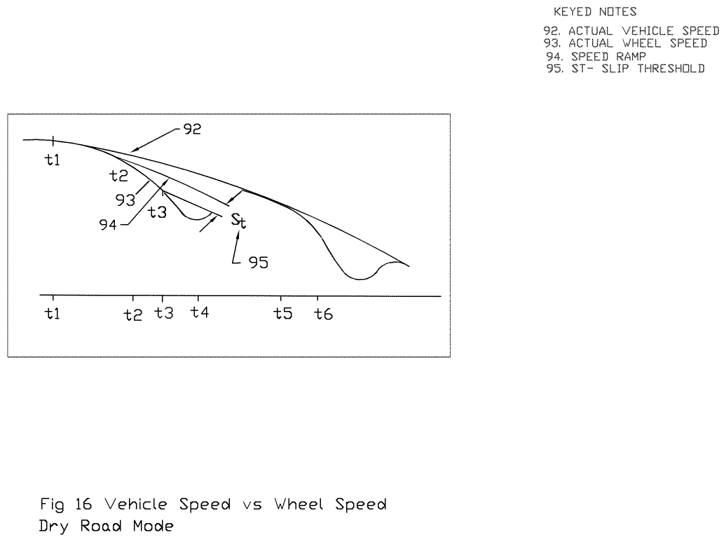

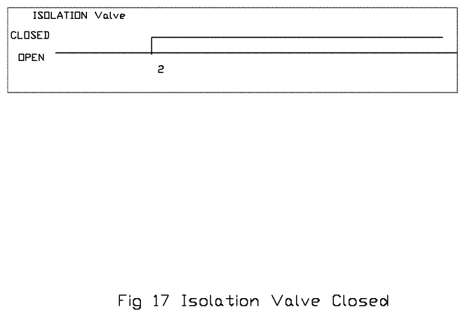

During vehicle operation in the dry mode/anti-lock mode, the microprocessor in the ECU 54 continuously receives speed signals from the wheel speed sensors 77a, 78a, 79a and 80a and from the spike position detectors (43 & 44) for each wheel via wireless remote terminal unit 45. The operation of the UBS operating in the dry mode/anti-lock brake with anti-skid is illustrated by the waveforms shown in FIG. 14, FIG. 16, FIG. 17, FIG. 18, & FIG. 19. A line labeled 90 in FIG. 14 illustrates the pressure being applied to one of the wheel brake cylinders as a function of time. At t₁, the brake pedal 67 FIG. 10 is depressed to begin applying pressure to the brake cylinders. The actual vehicle speed during the brake application as a function of time is illustrated by the line labeled 92 in FIG. 16. After t₂, the actual wheel speed 93 in FIG. 16 begins to decrease relative to the actual vehicle speed 92 in FIG. 16. Meanwhile, the microprocessor in the ECU 54 has calculated a theoretical speed ramp, shown by the dashed line labeled in FIG. 16 that represents the speed the vehicle would travel decelerated at a predetermined maximum rate, such as 1.0 g. The microprocessor continues to monitor the speed of the wheel relative to both the actual wheel speed and theoretical speed ramp. When the microprocessor detects that the wheel deceleration has reached a predetermined threshold value, such as 1.3 g, at t₂, the microprocessor causes the isolation valve associated with the wheel brake to close, as illustrated in FIG. 17, limiting the pressure applied to the wheel cylinder of a constant level P_{A} in FIG. 14. The uncontrolled wheel brake pressure would continue to follow the dashed curve labeled 95 in FIG. 14.

When the difference between the actual wheel speed 93 in FIG. 16 and the calculated speed ramp 94 in FIG. 16 exceeds a predetermined slip threshold Sₜ, it is an indication that a predetermined slippage is occurring between the actual wheel speed and the vehicle speed and that the wheel has potential to lock-up. This point is shown at t₃ in FIG. 16. At this time, the wheel speed has fallen sufficiently that it is desirable to selectively reduce the pressure of the hydraulic fluid being applied to the wheel cylinder. Accordingly, the ECU microprocessor applies a series of pulses labeled shown in FIG. 18 to the dump valve associated with the wheel cylinder to lower pressure sufficiently to cause the wheel to spin back up to the vehicle speed, beginning at t₄. The lowered pressure is labeled P_{B} in FIG. 14.

After the wheel speed attains the vehicle speed, it is desirable for the ECU microprocessor to apply a series of pulses at t₅ to the apply valve associated with the wheel cylinder to raise the pressure. The operation of the apply valve is illustrated in FIG. 19. These pulsed precipitates a second wheel speed departure at t₆. Upon correction of the second wheel speed departure with a second series of dump pulses, it is seen that the applied pressure P_{C}, while lower than the initial pressure P_{A} is greater than the pressure P_{B} present after correction of the first wheel speed departure. Thus, it is seen that the UBS provides control over the individual wheel speeds by switching between hold, dump of the solenoid valves included in the control valve 70 when operating in the dry mode.

Because the speed of each wheel is monitored separately, by utilizing a different algorithm for the microprocessor in the ECU 54, the system illustrated also may function as a Traction Control System (TCS) and/or a Vehicle Stability Control (VCS) system for dry, wet, ice and snow conditions and for slippery rigid surfaces and non-rigid surfaces when integrated with the wheel traction system.

“Smart Wheel” Improvements

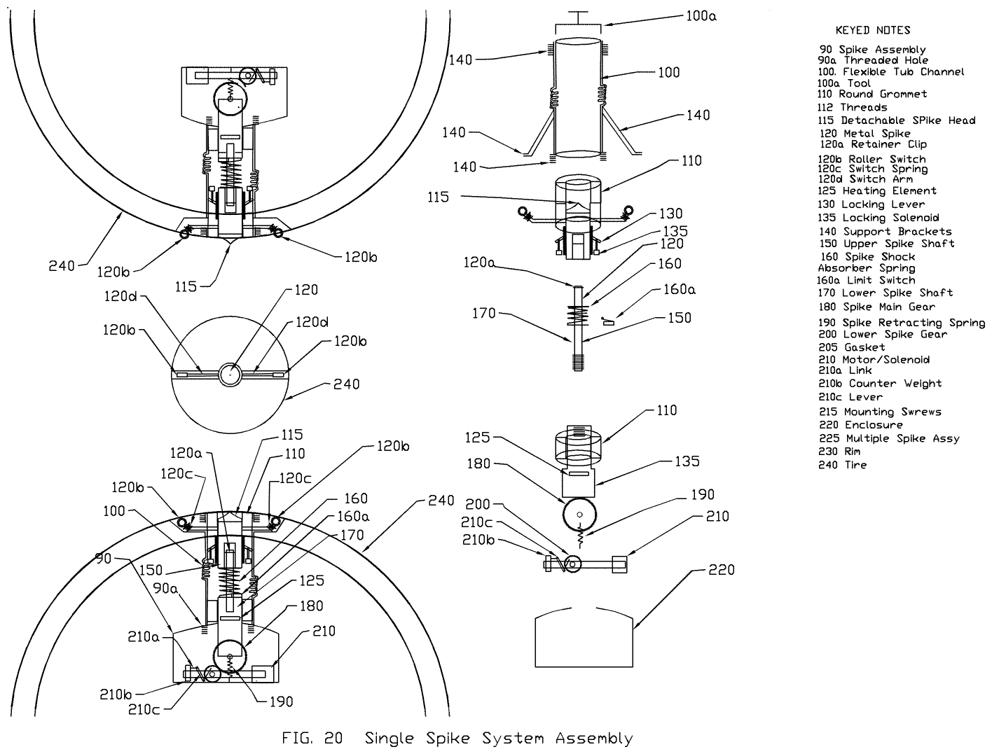

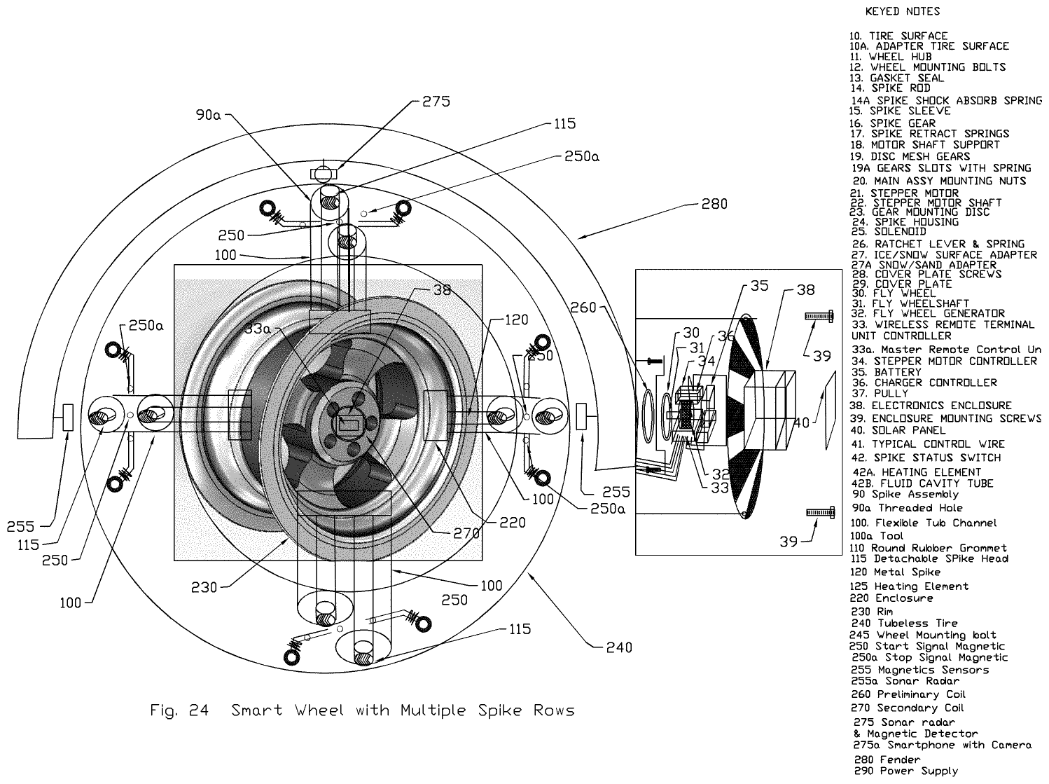

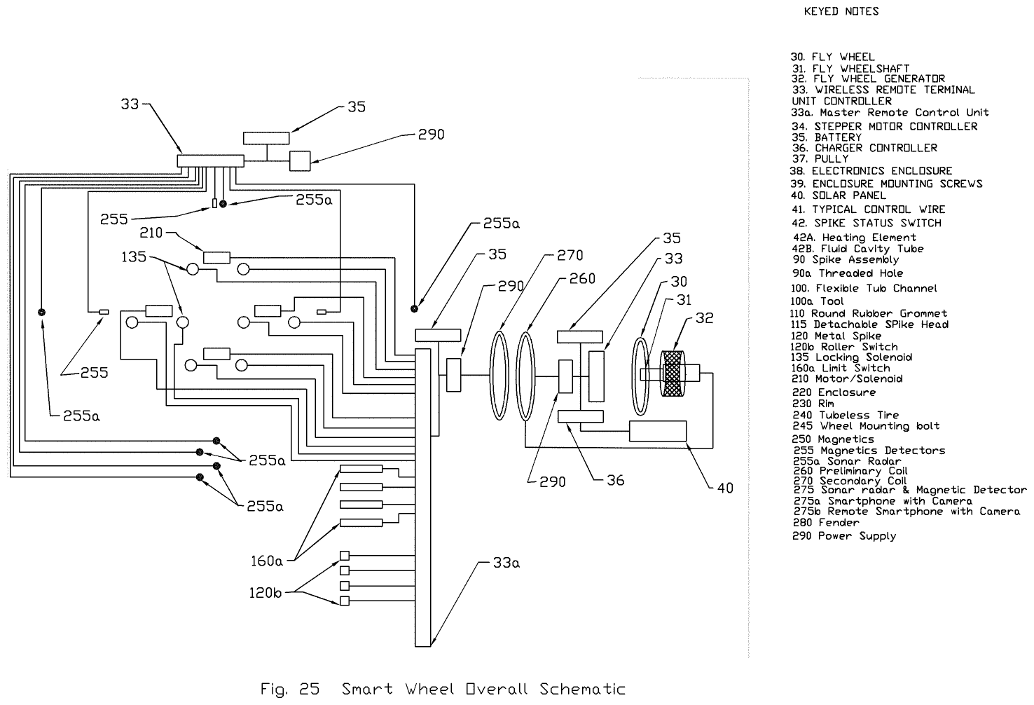

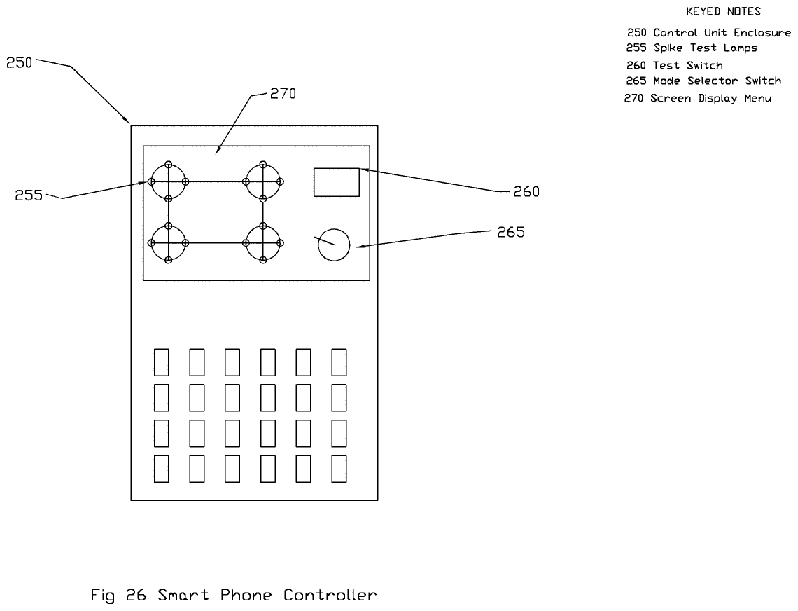

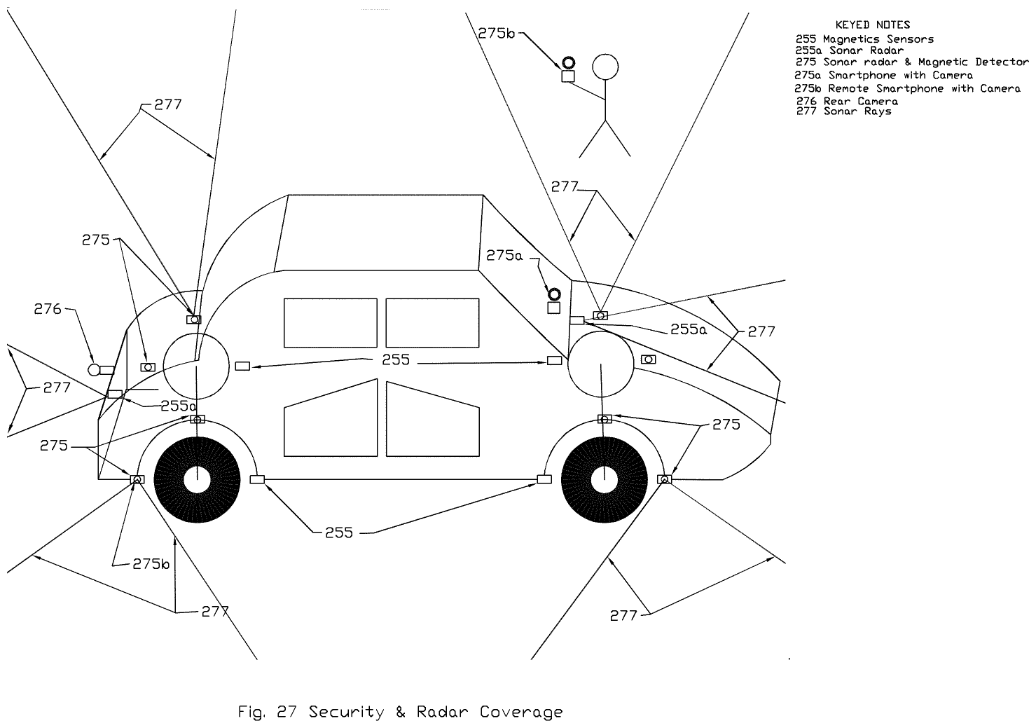

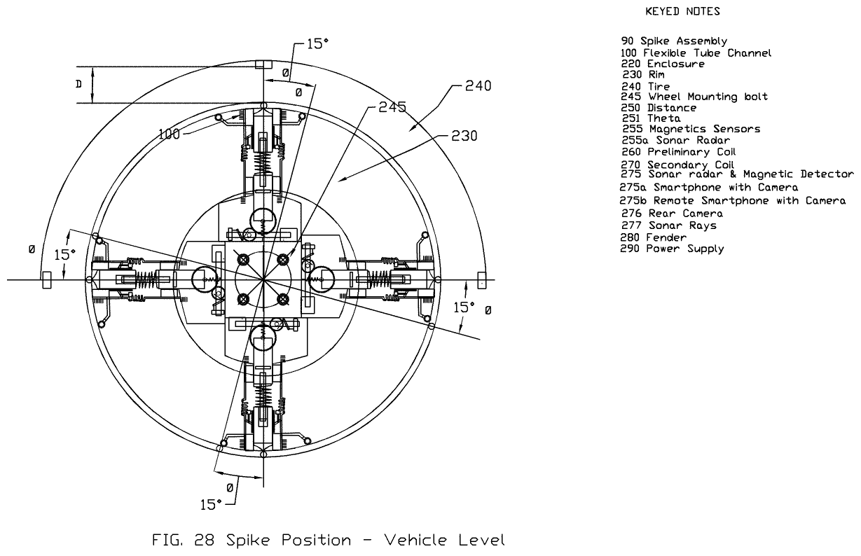

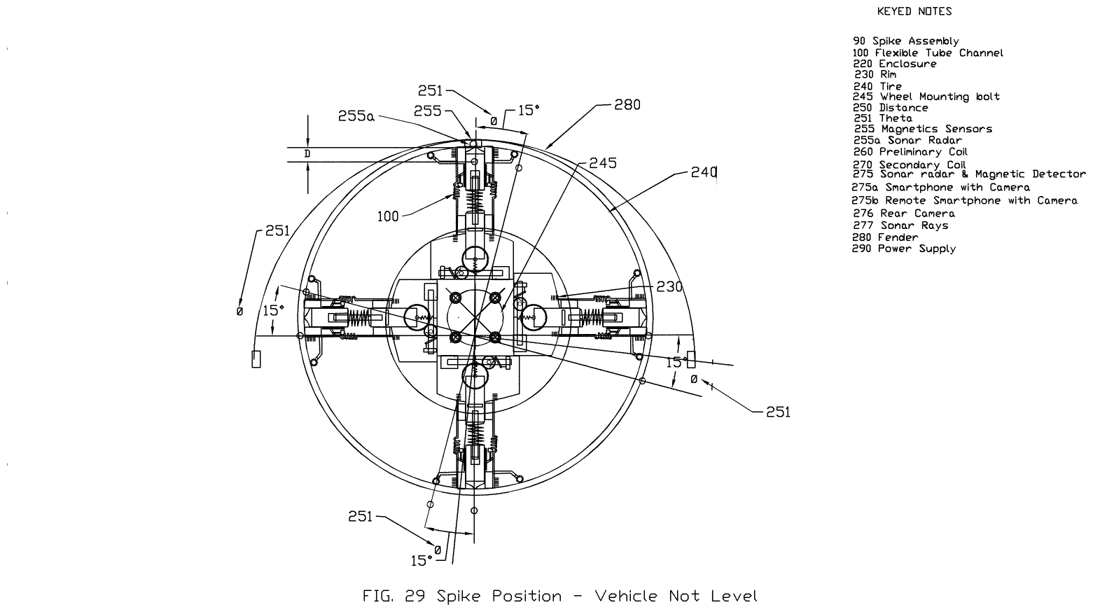

The smart wheel features are described in FIG. 20 through FIG. 29. The improvements consist of:

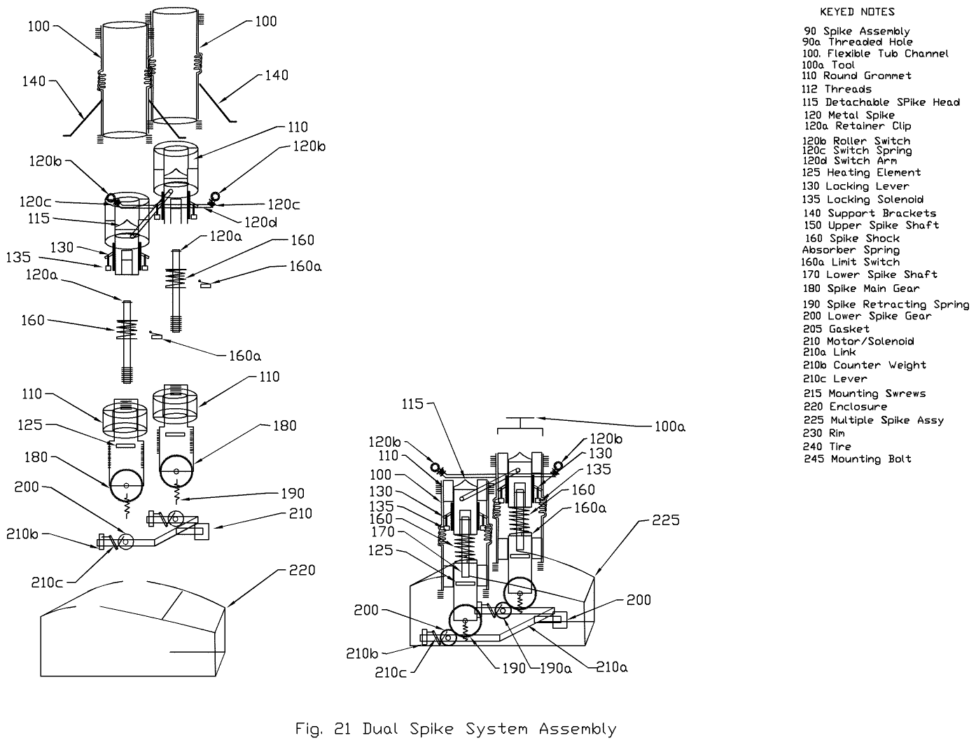

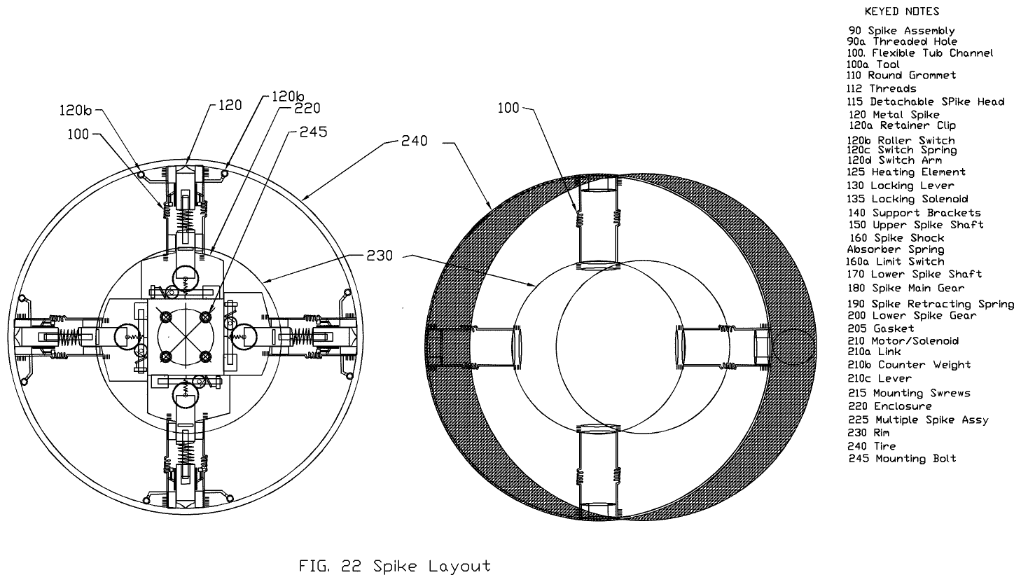

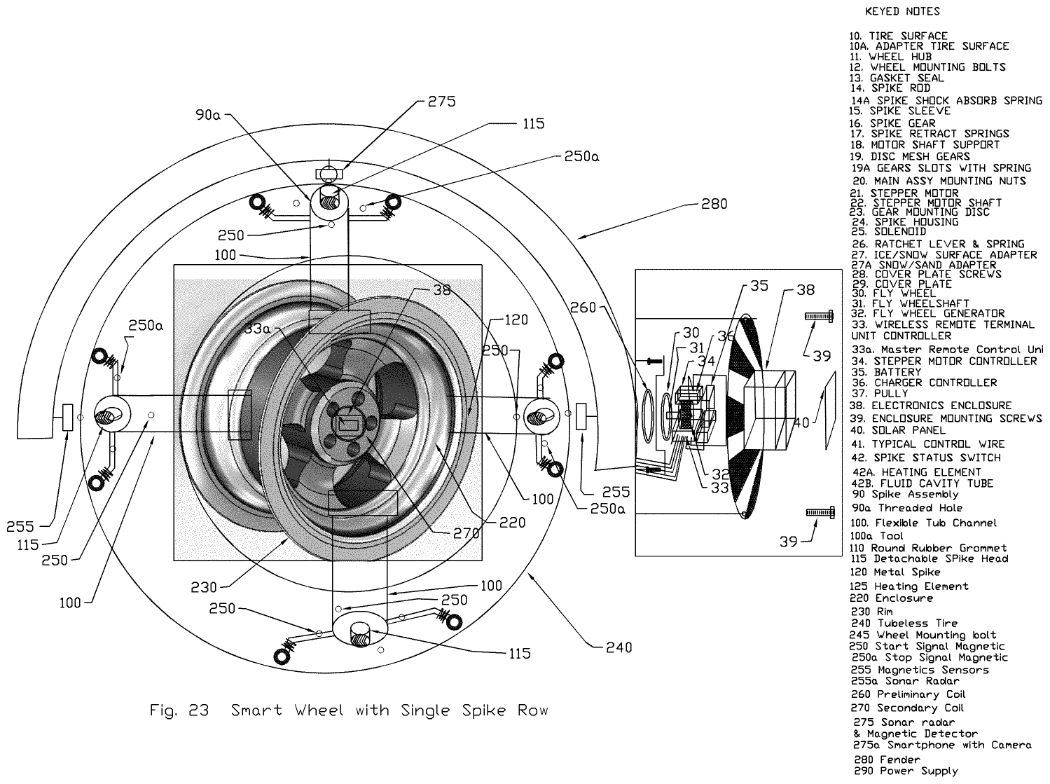

1). Each spike 120 has individual motor/linear actuators 210 with a lower spike gear 200 attached to the shaft of a linear actuator motor 210. When the linear actuator retracts it meshes the lower spike gear 200 with a spike gear 180 which causes a spike 120 to extend outward. The spike is retracted by the power of a spring 190 after being released by the locking ratchet levers 135. This gear assembly 90 is mounted in an airtight environmentally sealed enclosure 220 compartment in the bottom of the barrel part of a wheel's rim 230 between the outboard face and inboard rim edge. This configuration will allow each spike to be powered separately by its own motor/linear actuator motors 210 that is mounted radially along the barrel part of a rim 230. Furthermore, individually powered spikes 120 allow multiple rows of spikes FIG. 21 to be assembled adjacent to one another.

2) A tubeless tire 240 with a pularity of flexible tube channels 100 that is threaded at both ends and mechanically connected from the upper surface of a tire down to a wheel's rim barrel surface to form an air tight environmentally seal inside of a tire. Each flexible channel 100 allows each spike 120 to move freely inside of the flexible channel while allowing a tire 240 to remain inflated and keep its flexibility. Each spike 120 is mechanically connected to a roller switch 120b that extends and retracts with a spike. Each roller switch will touch a wheel supporting surface to close a switch which provide a starting signal to a wheel's remote terminal unit. Each tire has channels in its threads to allow a roller switch to move back and forth such that it can contact a wheel supporting surface when a spike is extended. A tire has magnets embedded in its tire tread surface. A magnet for start signal in front of a spike and a magnet co-located next to each spike. A tire is pressure fitted over a rim and weight balanced.

3) Each spike 120 has a spring 160 inserted in the head of the spike 120 on a shaft such that it allows the spike to freely move against the spring 160 to form a shock absorber. There is also a limit switch 160a located inside of shock absorber spring 160 which closes when a spike 120 compresses the spring when it meets a wheel's supporting surface.

4) Each spike 120b has a roller switch symmetrically and mechanically connected to each spike that moves when a spike moves. The roller switch provides a start signal to a remote terminal unit that that signals the universal brake system to start slowing down a wheel enough to be able to lock a wheel when a stop signal is generate when the shock absorber limit switch closes when a spike come in contact with a wheel's supporting surface.

5) Each spike 120 is heated individually by an electric heating element 125 embedded in each spike 120.

6) A means for multiple spikes 120 to be assembled in adjacent rows on a wheel's rim 230 and controlled by a single motor/solenoid 210.

7) A means to supply power from a fly wheel generator 32 mounted in a hub cap 38a on a wheel. Electrical power is inducted from a primary coil on a fly wheel generator to a secondary coil (via magnetic induction) that provides AC power to a power supply 290 that produce DC power for wireless remote-control units 33 and wheel electrical loads. There is a second power supply that receives AC power from the primary coil to produce DC power electronic loads inside of hub cap.

8) To assembly a smart wheel with spikes 120 requires the lower gear box assembly 90 to be installed in the enclosure area 220 of the barrel of a rim 230 first. After a tire 240 is installed on a rim, the upper spike 150 is screwed into the lower portion of the spike assembly 90 via a hole 240a in the tire 240. Next a flexible channel 100 which is threaded on both ends is screwed through a threaded hole 240a in the upper part of a tire until it drops down over a spike 120 and then threaded into hole 90a located in the rim 230 barrel. Next after applying thread bonding sealant to all threads and utilizing a notched hand tool 100a to simultaneously screw the flexible channel 100 into both the upper tire thread 240a and rim threaded 90a to form an air tight mechanical seal at both ends. The roller switches are installed by screwing their connecting rods into the side of each spike and then screwing the roller switch into the connecting rod. These steps are repeated for all remaining spike 120 positions. Afterwards a tire can be inflated via an air valve, sealed to rim and wheel balanced.

9) A manual mode is added to allow the spikes to remain extended at a depth determined by a vehicle operator.

10) Automatic mode is added to allow the adjustable traction system to automatically engage at any time skid conditions or wheel slip is detected by the wireless remote unit controller 33 located inside an environmentally sealed enclosure in the wheel.

11) Wet mode, ice mode, and snow mode is included that allow the spike to extend a predetermine distance based on road conditions.

12) Collision avoidance mode allows a smart wheel to work with the 360 degrees of sonar radar coverage to allow spike to extend if there is heavy braking and if a vehicle get within unsafe stopping distance to an object.

13) Parking assistance mode provide a vehicle operator with parking guidance using the 360 degree of sonar radar surveillance.

14) Security mode utilizes 360-degree radar zone coverage and a smart phone to provide a vehicle with radar zone coverage and emergency contact calling if a vehicle wheel speed is detected by a remote terminal unit. There are also optional alarms that connect to a vehicle's horn and lights.

15) The “Smart Wheel” with adjustable wheel traction can also be integrated into a vehicle's universal brake system to allow for locking a wheel on a spike using several methods.

15a. The first method consists of installing magnetic sensors 255, along with a sonar distance measuring radar 275 in the top of a vehicle's wheel well. There is also a start magnet installed in a tire in front of a spike and a stop magnetic 250 installed 240 next to the same spike to generator a start and stop signal when a spike 120 passes by a magnetic sensor 255. A magnetic sensor 255 is located on the left and redundant one on the right side of a wheel well at right angles to a vertical line through the center of a wheel. A third backup magnetic sensor 255 is co-located a long with a sonar radar 275 at the top of a wheel's well on a center line through a wheel. A remote terminal unit (rtu) measures the angular velocity of a wheel by measuring the time between a set of start and stop signals and dividing the angle (theta) between start and stop signals by the measured time. The distance measuring sonar radar 275 sensors is used to measure the distance from the radar device 275 to the top of wheel surface to determine how much a vehicle body has moved from its level position. This normal level distance is stored as a reference distance in a wheel's remote-control unit (rtu) memory and is compared to future measurements to determine when a vehicle is not level. When a vehicle is level the left and right magnetic detectors 255 will lined up with a stop magnet for a spike which puts one spike at right angles directly under a wheel's supporting surface. Therefore, a vehicle's braking system can be signaled with a start signal to start slowing a wheel to prepare for a wheel lock when the corresponding stop signal is generated. Furthermore, it is important to note that the distance between the start and stop detector is set for a predetermine wheel angular velocity response time that is at least equal or greater than the braking system mechanical system response time for wheel locking conditions. This configuration will insure that a vehicle's braking system has enough time to stop a wheel precisely on a spike after receiving a start signal from the master rtu followed by a stop signal.

15b. However, if a vehicle body is not level, then that means the magnetic detectors have moved an arc distance a long a wheel from the level position. Therefore, to compensate for this movement the radar measuring device at the top of each wheel measures the distance from the top of a wheel to the radar device and an rtu compares that newly measured distance to the reference level distance.

If the distances are not equal, then the vehicle body is not level. Therefore, the difference between the reference distance and newly measure distance is equal to the offset distance which is estimated to be equal approximately to an arc length a long a wheel that a magnetic detector 255 has been displaced. Hence, this offset arc length is divided by the angle velocity of a wheel to arrive at a compensating time and assuming the vehicle's body moved down, then the time between start and stop signals at a predetermine angular velocity will be reduced by the compensating time by a vehicle's braking system in-order to stop a wheel on the next available spike. The opposite is true if the body of a vehicle body has moved up in a wheel well.

15c. A third method for locking a wheel on a spike consist of using the top of the wheel magnetic detector. This method simply requires a start signal to be sent via an rtu to the universal brake system to alert it to slow a wheel down to a predetermined speed for lock wheel conditions followed by a stop signal which signals to a rtu to provide a lock wheel signal to the universal brake system. Therefore, since the spikes are located every 90 degrees then there is spike 180 degrees from the spike at the top of a wheel and under the supporting surface of a wheel.

15d. A fourth method for locking a wheel on a spike consist of situations where a wheel may be traveling too slow to generate a magnetic start and/or stop signal. Therefore, a series of mechanical roller switches 120b have been installed that mechanically connects a pair of roller switches directly to each spike via an arm such that when a spike extends or retracts it extend and retracts the roller switch ahead of each roller each spike. The roller switch comes in contact with a wheel's support surface before a spike does to generate a start signal that is sent directly to each wheel's rtu, then to the master rtu which signal the universal brake system to begin to slow a wheel down so that a wheel can be stopped and locked instantly when the limit switch 160a in each spike's shock absorber is closed when a spike comes in contact with a wheel's supporting surface. This scenario assumes that a wheel is traveling at slow enough speeds to be stopped instantly under wheel lock conditions based on the mode of operation of the universal brake system.

16. Furthermore, a master rtu prioritizes each of the above spike tracking methods base on the following sequence: It reads for a valid signal from the top magnetic detectors first, then checks the left magnetic detector, then the right magnetic detector for valid signals, and lastly the rtu checks for a valid signal from a roller switch 120b and the shock absorber limit switch 160a.

17. When the “Smart Wheel” operates as a standalone adjustable traction system it not integrated to a vehicle's universal brake system and therefore does not offer the wheel locked features. In addition, the limit switches 120b and roller switches 160a are not utilized in the standalone mode. Furthermore, the standalone mode utilizes its own wireless remote computer controller 33 embedded in each wheel to measures wheel speed using the magnetic sensors 255 and one wheel serves as a master controller that utilize wireless communications to collect wheels speed data and sonar data from the other wheels in real-time and compares their speeds to the other wheels speeds to make the following minimum decisions:

a) Lost of traction—If the main power wheel is rotating faster or slower than the other three wheels. Then the spike controller for each smart wheel issues a signal to cause each motor/solenoid to extend based on selected road conditions (dry, wet, ice or snow) for as long as slip conditions are measured and then for an additional predetermined amount of time before retracting the spikes.

b) Vehicle is skidding—This will show up in wheel speed measurement as wheel slip or difference in wheel speeds and therefore the spikes will be extended accordingly to gain traction based on selected mode of operation (dry, wet, ice or snow). Skidding may also take place as result of wheels being locked up due to heavy braking which will also cause spikes to be extended accordingly until heavy braking has stopped.

The “Smart Wheel” will also contain the following optional features using a “Smart Phone” software application:
The ability to control and monitor all functions of a Smart Wheel system via wireless communication with a smart phone using a human machine interface (HMI) application. Monitoring and control items include a minimum of spike status, geographical positioning system (GPS) data, magnetic compass heading data, wheel speed data and sonar radar data.
Ability to visually graph skid data using wheel speed data and magnetic compass heading data from GPS.
Remote data storage with date time stamped database
Graphically display vehicle configuration of sensors with test function
Maintenance Log—Ability to track vehicle maintenance records and receipts using camera to record and storage copies of maintenance repair receipts, and ability to track individual tire mileage.
Unsafe Distance—Utilize sonar radar sensors located in front, rear and on each side of vehicle to detect distance from an object and automatic engage spike system if heavy braking is demanded if vehicle gets too close to an object to stop safely and provide visual and audible alerts.
Parking Assistance—Provide visual and audible alerts during parking when a vehicle reaches a preset distance from an object. Also provide visual display of vehicle distance from an object.
Collision Detection—Ability to detect if a vehicle has crashed by comparing sonar distance data with vehicle wheel speed data. For example, a minimum crash conditions will be detected if the sonar sensors read a distance equal to zero or an offset distance to the front edge of vehicle bumper and wheel speed greater than zero or a predetermine speed.
Collision avoidance—Extend spikes during heavy braking and provide a visual and audible warning if vehicle reach unsafe stopping distances from an object based on sonar radar and mode of operation of smart wheel.
Emergency Call—Once a vehicle crash is detected and after a predetermined time delay, a command is sent from a smart wheel wireless rtu to a smart phone controller to dial the nearest emergency contacts and provide a minimum amount of emergency information including:
   Name of Driver, Number of passengers, GPS location of vehicle, return phone number, speed of vehicle at impact, and compass heading of vehicle during impact.
Security Mode—Each sonar radar sensors distance range is preset able to a predetermined distance for detecting an object mainly when a vehicle is setting still. Therefore, when an object is detected inside a detectable range then there are several selectable alert options: 1) A vehicle horn blows, 2) Vehicle lights flash, 3) Video and/camera inside vehicle is activated to take pictures, 4) All data and information can be transmitted wireless to a smart phone. 5) If a vehicle is stolen, the smart wheel controller will utilize the emergency call feature mentioned above plus call vehicle owner with same information. Other features of the security mode include:
   In the security mode, a vehicle will be considered stolen if one or more of its sonar security zones is breached and with a detection of wheel speed data after a breach of a security zone.
   In the security mode, a separate smart phone controller remains inside a vehicle to provide global position system services and cellular communications with a remote smart phone.

1. A smart wheel with an adjustable wheel traction system comprised of a smart phone controller, a tire with magnetics embedded in a tire, a wheel rim, a pularity of flexible tube channels, a pularity of magnetic detectors, a start signal tire magnet, a stop signal tire magnet, a radar device, a multiple piece spike shaft with an upper and lower sections, a spring for absorbing shock, a limiting switch inside of shock absorber, a spike gear, a disc gear, a spike roller switch, an individual motor/linear solenoid, a counter weight, a wireless remote terminal unit (rtu) in each wheel, a master remote terminal unit, a fly wheel generator, a primary and secondary induction coil, a power supply, a solar panel, a smart phone, a smart phone camera, a battery, a charge controller; a heating element, an enclosure; a support grommet; characterized by a means for a tire and rim to house flexible tube channels that mechanically connect to a tire and barrel of rim while maintaining an inflated tubeless tire and allowing a spike to mechanically extend and retract inside a flexible channel and remain environmental sealed; characterized by a means for a tire to house magnetics inside of tire surface to generate a start signal and stop signals for said detectors in wheel wells; characterized by a means for said radar to detect an object from a distance, measure distance and provide audible and visual alerts; characterized by a means for upper and lower spike shaft to interlock, characterized by a means for spikes to absorb shock, characterized by a means for limiting switch to operate when spike is on contact with a wheel supporting surface, characterized by a means for a spike roller switch that comes in contact with a wheel's supporting surface when a spike is extended and generates a start signal to a wheel's rtu; characterized by a means for individual motor/linear actuator to extend a spike outward by moving spike gears and retracting spike under the power of a spring; characterized by a counter weight to move in opposite direction of said motor/linear actuator to dynamically keep wheel mechanically balanced, characterized by a means for each spike gear assembly to be powered by individual motors/linear actuators arranged radially around a wheel's rim characterized by a means for controlling motor/linear actuator with either by a universal brake system controller or independently by wireless remote controllers embedded in each wheel with one wheel serving as a master controller, characterized by a means for a fly wheel to turn a generator to generate electricity and using a primary and secondary coil to induce power into a power supply which powers electrical loads; characterized by a solar panel that charges a battery via a charge controller; characterized by said electric heating element to heat spike assembly; characterized by said smart phone and smart phone camera for communicating with wireless remote terminal unit and characterized by a means for an enclosure to house both mechanical and electrical parts.

2. A smart wheel with an adjustable wheel traction system in accordance with claim 1 further comprised of a smart phone controller with multiple mode selections including: automatic, manual, wet, ice, snow; characterized by a means to operate in automatic mode where all selected feature engages automatically; characterized by a means for manual operation where selected features are engaged on an individual basis; characterized by a means to select wet mode where said spikes extend and retract a predetermine distance for wet road conditions; characterized by a means to select icy mode where said spikes extend and retract a predetermine distance for ice road conditions; characterized by a means to select a snow mode where said spikes extend and retract a predetermine distance for snowy road conditions.

3. A smart wheel with an adjustable wheel traction system for a vehicle according to claims 1 and 2, further comprised of a smart wheel that operates independent of a vehicle's braking system as a standalone adjustable traction system, wherein in all wheels are configured with a remote terminal unit except one wheel serve as a master slave control unit to receive data via wireless communication from all other wheel; characterized by a remote terminal unit (rtu) with a means to detect a start and stop signal using a plurality of magnetic detectors located in wheel wells which detects a start and stop signal generated from magnets embedded in each wheel's tire; characterized by a means for said rtu's to measure the angular velocity of a plurality of wheels by measuring the time between each wheel's start and stop signals which measures the change in the of angle theta in degrees between the start and stop detectors and then by dividing angle theta by the measured time to derive at angular velocity for each wheel; characterized by each wheel's rtu's ability to transmit data via wireless communication to a master remote controller that compares each wheel's angular velocity to determine to what degree of slip has occurred based on a predetermined threshold and then determine whether not to issue a signal to all said rtu's to cause all wheels to extend their spikes at a predetermined wheel speed for a predetermined amount of time based on the smart wheel mode configuration before retracting spikes;

4. A smart wheel with an adjustable wheel traction system for a vehicle according to claims 1 and 2, wherein said smart wheel is integrated with a universal braking system; characterized by a means for tracking a wheel's spike position consist of using the top of the wheel magnetic detector; characterized by a means to use the top wheel detector to generate a start signal and stop signal from the magnetic in a tire and send it to a wheel's rtu and master rtu and then to the universal brake system to alert a vehicle's brake system to slow a wheel down to a predetermined speed for wheel lock conditions and lock a wheel upon receiving a stop signal; characterized by spikes are located every 90 degrees such that there is spike 180 degrees from the spike at the top of a wheel and under the supporting surface of a wheel during wheel lock conditions.

5. A smart wheel with an adjustable wheel traction system for a vehicle according to claims 1 and 2, wherein said smart wheel is integrated with a universal braking system; characterized by a means for tracking a wheel's spike position when a vehicle body is level and using left and right side redundant magnetic signal detectors; characterize by a means for a remote control unit to measure a wheel's spike position by using detectors in a wheel well to measure both a wheel's angle velocity according to claim 2, characterized by a means to electronically measure the distance from the top of a wheel to the distance measuring device and used that measured distance as a reference distance to determine if a vehicle body is level; characterize by a means for a remote control unit to compare said top of wheel reference distance to a newly measured wheel distance and determine if a vehicle body is level if the two distances are approximately equal then a vehicle body is level; characterized by a means to determine that a wheel turning at a measured angle velocity and with a start signal detected by a wheel well detector indicates that a spike is located at a right angle to the detector and therefore a spike is located under the supporting surface of a wheel 90 degrees from a detector and a master remote control unit can send angle velocity data, start signal data to a universal brake system to begin slowing down a wheel to prepare it for wheel lock conditions when after receiving a stop signal during heavy braking conditions.

6. A smart wheel with an adjustable wheel traction system for a vehicle according to claims 1 and 2, wherein said smart wheel is integrated with a universal braking system; characterized by a means for tracking a wheel's spike position when a vehicle body is not level and using left and right side redundant magnetic signal detectors; characterized by a mean to compensate for a vehicle body movement by a means for measuring the distance from the top of each wheel's to the measuring device when a vehicle is level and comparing it to a newly measured distance when a vehicle body is not level; characterized by if the reference level distance is not equal to the newly measured distance, then the vehicle body is not level; characterized by the difference between the reference distance and newly measure distance is equal to an offset distance which is estimated to be approximately the arc length a long a wheel that a magnetic detector 255 has been displaced; characterized by this offset arc length being divided by the angle velocity of a wheel to arrive at a compensating time to reduce the time between a start and stop signal if a vehicle body has move down and increase the compensating time if a vehicle body has moved up by a vehicle's braking system in-order to stop a wheel on the next available spike.

7. A smart wheel with an adjustable wheel traction system for a vehicle according to claims 4,5,6 and 7, wherein said smart wheel is integrated with a universal braking system; characterized by a master rtu with the means to prioritize multiple means for tracking a wheel's spike; characterized by the means for the master rtu to prioritize the multiple spike positioning methods based on the following sequence: if a valid signal from the top magnetic detectors is read first then the top sensor method is used, if a valid signal is read from the left magnetic detector and then the right magnetic detector is used otherwise the rtu checks for a valid signal from a roller switch 120b and shock absorber limit switch 160a to use that method for controlling a spike's position during wheel lock conditions.

8. A smart wheel with an adjustable traction system for a vehicle according to claims 1 and 2 wherein all smart wheel functions can be controlled and monitored via software applications operated on a computerize smart phone with global positioning system, camera, internet, Wifi, Bluetooth and cellular phone communications; characterized by a means for software application to control, monitor and test all functions of a smart wheel system, characterized by a means for collecting and monitoring geographical positioning system (GPS) data, characterized by a means for tracking and displaying magnetic compass data, characterized by a means for collecting and monitoring wheel speed, magnetic signal detection, radar data and camera data; characterized by a means to visually graph data; characterized by a means for storing and retrieving data remotely with date time and stamp; characterized by a means for two way cellular communications from a smart phone located in a vehicle to a remote smart phone; characterized a means for storing and retrieving electronic document files with date and time stamp; characterized by a means for providing audible and visual alarms, characterized by a means for detecting a vehicle collision by utilizing 360 degree radar zone coverage to detect an object from a preset range and automatic engage spike system if heavy braking is demanded or if vehicle is too close to an object to stop safely and provide an visual and or audible alerts, characterized by a means to provide lane changing guidance by utilizing 360 degree radar zone coverage to detect an object and provide a visual and audible alerts; characterized by a means for providing parking guidance using 360 radar coverage with audible and visual alerts if vehicle gets too close to an object based on preset distances, characterized by a means for detecting that a collision has occurred by comparing radar object detection data with a vehicle wheel speed data and determining that a collision has occur if an object was detected at a distance equal to zero or an offset distance to the front edge of a vehicle bumper and a vehicle's wheel speed greater than zero or a preset minimum speed; characterized by a means for automatically make an emergency call to the nearest emergency services (police or ambulance services by searching geographical positioning system (gps) maps, google internet search engine and providing emergency contacts with personal contact information, vehicle identification information, gps location data, compass heading, and vehicle speed data; characterized by a means for establishing vehicle security using 360 degree radar zones with selectable distance range to detect an object mainly when a vehicle is sitting still and if an object breach a radar zone area for a predetermined amount of time, then an audible alarm is triggered, a visual alert displayed on remote smart phone and optionally vehicle lights turned, vehicle horn blows, and a vehicle smart phone camera inside vehicle is activated to take a picture of the interior of a vehicle and send it to a remote smart phone; characterized by a means to monitor wheel speed in security mode and if wheel speed is detected then activate said emergency call services.
